(19) United States
(12) Patent Application Publication
(10) Pub. No.: US 2010/0023528 A1
(43) Pub. Date: Jan. 28, 2010

(54) EMERGENCY MEDICAL INFORMATION SERVICE AND HEALTH RECORDS SYSTEM

(75) Inventor: Stephanie L. Cion, New York City, NY (US)

Correspondence Address: OCCHIUTI ROHLICEK & TSAO, LLP, 10 FAWCETT STREET, CAMBRIDGE, MA, 02138, US

(73) Assignee: WELLalarm LLC, New York, NY (US)

(21) Appl. No.: 12/495,939

(22) Filed: Jul. 1, 2009

Related U.S. Application Data
(60) Provisional application No. 61/080,863, filed on Jul. 15, 2008.

(51) Int. Cl. G06F 17/30

(52) U.S. Cl. 707/10; 707/E17.01

(57) ABSTRACT

A method for accessing a person's medical information in an emergency, the medical information stored in a database of a medical records system includes calling an emergency telephone number; entering an access code to access the medical records system; receiving a prerecorded message reciting the medical information; in response to a prompt by the medical records system, choosing to receive the person's medical information via a text message to a cellular telephone; and receiving on a cellular telephone the text message containing the person's medical information. The steps of calling the emergency telephone number and entering the access code cause the medical records system to automatically notify at least one emergency contact of the person. A telephone number for the at least one emergency contact is stored in the database of the medical records system.

### CROSS-REFERENCE TO RELATED APPLICATIONS

This application claims the priority of the U.S. Provisional Application No. 61/080,863, filed on Jul. 15, 2008, the content of which is hereby incorporated by reference in its entirety.

### FIELD OF THE INVENTION

This invention relates to an emergency medical information service and health records system.

### BACKGROUND

In the event of a medical emergency, a person may be unable to communicate his or her medical conditions or needs to emergency responders. However, it is often necessary for the emergency responder or bystander to be aware of these medical conditions in order to provide proper medical treatment to the person. To ensure appropriate medical treatment in an emergency, a person may carry a list or description of his or her medical conditions that can be accessed by the emergency responder or bystander. For instance, medical alert jewelry, such as a necklace, bracelet, or watch, displays a recognizable medical symbol to alert emergency responders to its presence and may also contain a brief list or summary of a person's medical conditions. This information may be engraved or printed on the jewelry, or the jewelry may have a small compartment inside of which a more detailed description of the medical information can be stored. Some medical alert jewelry also lists a phone number which can be called to retrieve additional medical information. Other medical alert jewelry contains electronics that allow electronic storage of and access to medical records.

### SUMMARY

In one aspect, this invention relates to a method for accessing a person's medical information in an emergency, the medical information stored in a database of a medical records system. The method includes calling an emergency telephone number; entering an access code to access the medical records system; receiving a prerecorded message reciting the medical information; in response to a prompt by the medical records system, choosing to receive the person's medical information via a text message to a cellular telephone; receiving on a cellular telephone the text message containing the person's medical information. The steps of calling the emergency telephone number and entering the access code cause the medical records system to automatically notify at least one emergency contact of the person. A telephone number for the at least one emergency contact is stored in the database of the medical records system.

In another aspect, this invention relates to a medical records system for providing access to a first person's medical records, the medical records stored in a database of the medical records system. The medical records system includes a non-emergency access module configured to: accept input of or modifications to the medical records by the first person, contact the first person with a reminder of an upcoming medical event by sending a text message to a first cellular telephone to which the first person has access, accept from the first person a selection of a subset of the medical records as emergency medical information, and accept from the first person a designation of at least one emergency contact; and an emergency access module configured to: accept a phone call to an emergency telephone number from a second person, identify the first person's medical records by an access code entered during the phone call by the second person, send a text message to a second cellular telephone to which the second person has access, the text message containing the emergency medical information, and automatically notify the at least one emergency contact of the first person. In some embodiments, the first person inputs or modifies the medical records by faxing medical records to the medical records system or by using a mobile communication device.

In a further aspect, this invention relates to a method for accessing a person's medical information in an emergency, the medical information stored in a database of a medical records system. The method includes obtaining an address of an emergency website and an access code; accessing the emergency website using a computer; entering the access code to access the medical records system; viewing the person's medical information on the emergency website. The steps of accessing the emergency website and entering the access code cause the medical records system to automatically notify at least one emergency contact of the person. A telephone number for the at least one emergency contact is stored in the database of the medical records system.

Embodiments may include one or more of the following. The emergency contact of the person is automatically notified by an email message, a text message, or a telephone call. The access code is displayed on an item, such as a jewelry charm, carried by the person. The person may possess a plurality of items, each item having a different access code, each different access code usable to access the person's medical information.

A medical records system as described herein has a number of advantages. The system allows a user to store and access medical information via the Internet, telephone, or fax. The interactive nature of the system, which provides for multimedia inputs, reminders, and alerts, enables a user to take advantage of the stored medical information to improve his or her health and wellness. This everyday wellness access combined with emergency access to selected emergency medical information in an emergency situation provides the user with a complete solution to managing his or her health information.

### BRIEF DESCRIPTION OF DRAWINGS

FIG. 1 is a cartoon depiction of a medical records system.

FIG. 2 shows a charm displaying information to access the medical records system.

FIGS. 3A and 3B show a cartoon depiction and a flow chart of the emergency access procedure.

FIGS. 4A-4E are screenshots of the basic medical information page of the medical records system.

FIGS. 5A and 5B are screenshots of the medication information pages of the medical records system.

FIG. 6 is a screenshot of the healthcare providers page of the medical records system.

FIG. 7 is a screenshot of the insurance information page of the medical records system.

FIG. 8 is a screenshot of the calendar page of the medical records system.

FIGS. 9A and 9B are screenshots of the emergency information pages of the medical records system.

### DETAILED DESCRIPTION

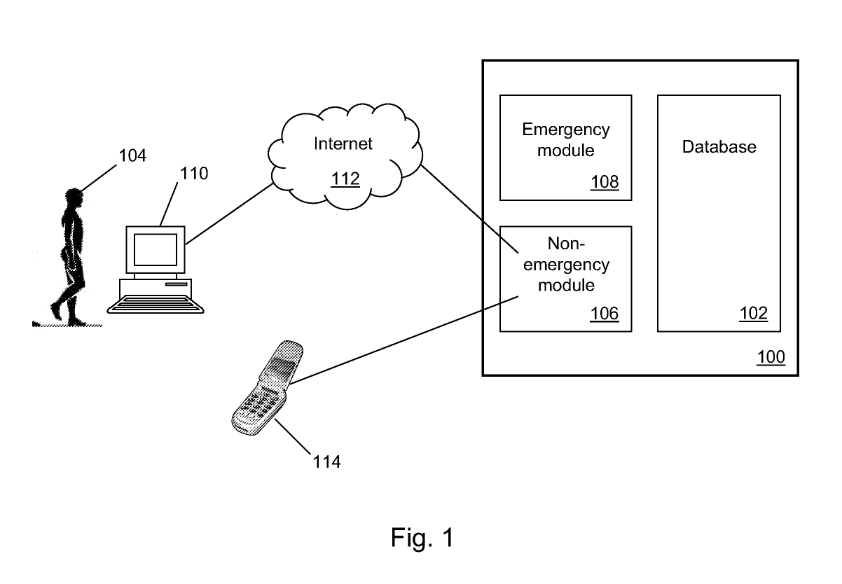

Referring to FIG. 1, a medical records system 100 provides both non-emergency and emergency access to a database 102 containing a user's medical records. For instance, database 102 may store medical information such as blood type, illnesses or medical conditions, allergies, implanted medical devices, immunizations, current and previous prescription and non-prescription medications, healthcare providers, limited insurance information, emergency contacts, and a schedule of medical appointments or other health-related events. Medical records system 100 contains a non-emergency module 106 and an emergency module 108, which are software modules that reside on a server and are programmed to allow non-emergency and emergency access, respectively, to medical records system 100. For non-emergency access, a user 104 establishes an account in medical records system 100 and accesses non-emergency module 106 of the account through a computer or other mobile device 110 connected to the Internet 112. Through non-emergency module 106, user 104 inputs his or her medical information to database 102 and views medical information previously entered into database 102. If requested by user 104, non-emergency module 106 is configured to send reminders by text message to a cellular telephone 114, by voice message to a telephone, or by email to computer 110 of events stored in database 102, such as a medical appointment, a time to take a medication, or a need to renew a prescription. User 104 may also select certain medical information to be transmitted by a voice message, text message, or Internet message by emergency module 108 and may designate emergency contacts to be alerted in the event of a medical emergency, as described below.

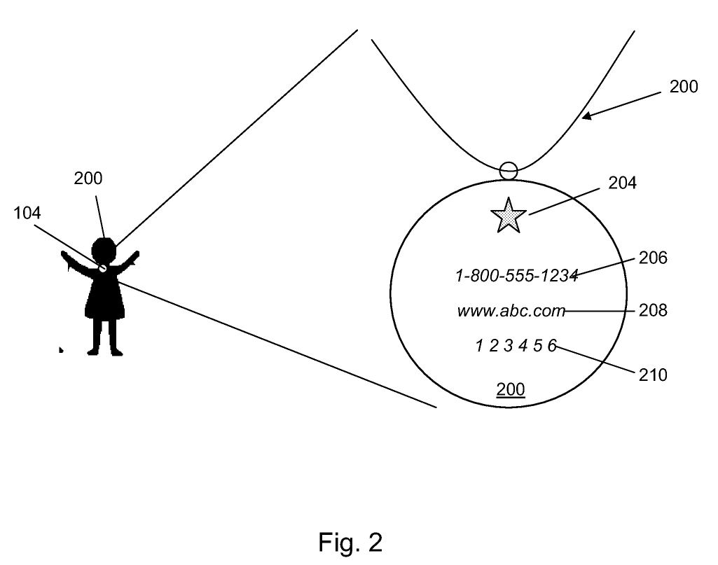

Referring to FIG. 2, information to enable access to emergency module 106 of medical records system 100 is inscribed, printed, or otherwise recorded on a charm 200. In other embodiments, the information may be included on other items such as clothing or sneaker labels, stickers for telephones, wallet cards, or keytags. User 104 wears or carries charm 200 on a piece of jewelry such as, for instance, a necklace 202, a bracelet, or a keychain. A medical insignia 204 is displayed on charm 200 to draw attention to the charm in the event of an emergency. An emergency telephone number 206, a website address 208, and an emergency access code 210 are also displayed on charm 200. User 104 may have multiple charms, for instance to wear on different pieces of jewelry, with each charm displaying a different emergency access code 208. Through non-emergency module 106, user 104 can configure medical records system 100 to link each different emergency access code 208 to his or her account. In this way, emergency medical information about user 104 can be accessed in the event of an emergency regardless of which charm he or she is wearing.

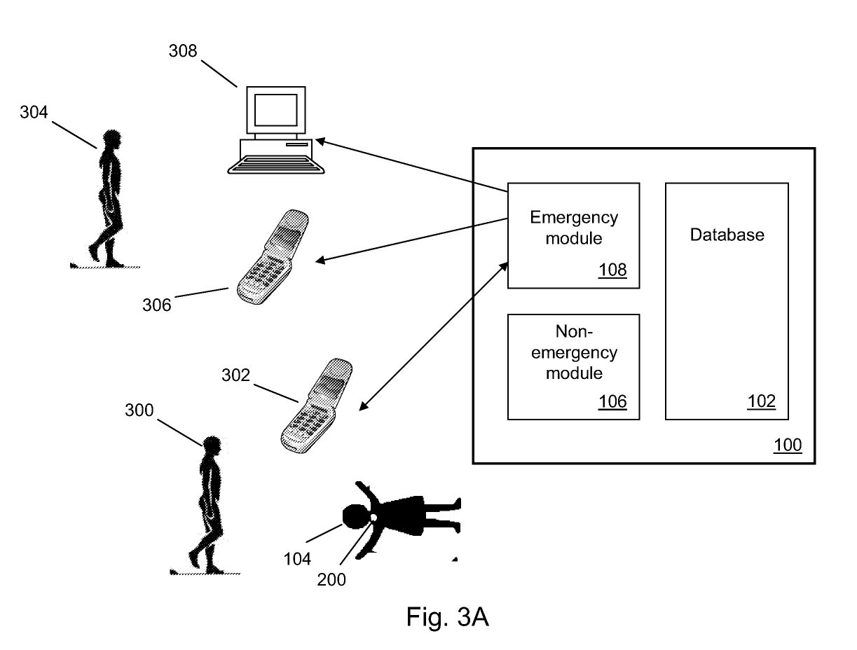

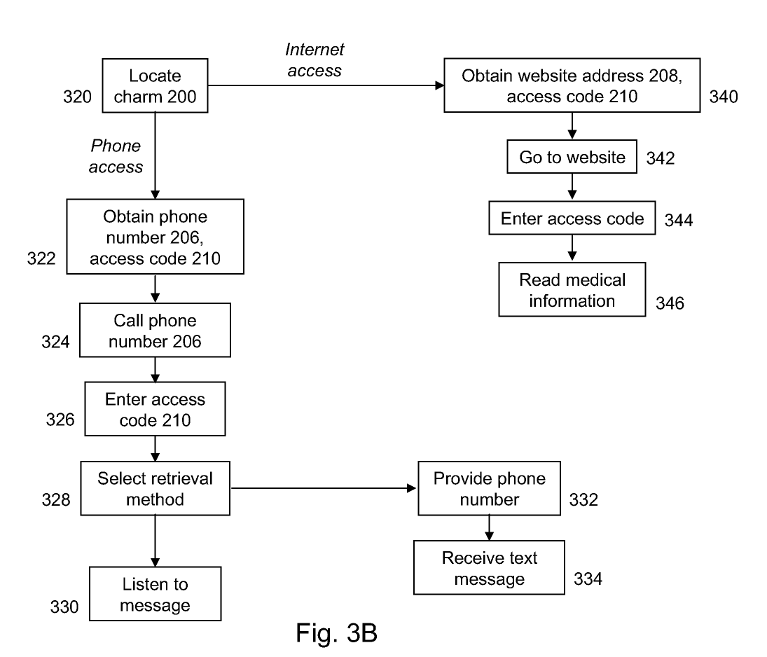

Referring to FIGS. 2 and 3A, if a user 104 has a medical emergency, an emergency responder 300 (e.g., an emergency medical technician, paramedic, nurse, physician, or bystander such as a teacher in a classroom) accesses emergency module 108 of the user's account in medical records system 100 to obtain emergency medical information about the user. Medical insignia 204 displayed on charm 200 worn or carried by user 104 alerts emergency responder 300 that charm 200 is of the type that includes information desirable for obtaining important medical information. Emergency responder 300 uses a telephone 302 to call emergency telephone number 206 and to log into emergency module 108 of medical records system 100 using user 104′s emergency access code 210. Once logged in, emergency responder 300 listens to a recorded voice message that recites the medical information. The emergency responder is then given the option to hear the message again or to receive the message as a text message to a cellular telephone 302. In particular, emergency module 108 provides a prerecorded voice message or text message that recites emergency medical information preselected by user 104 prior to the medical emergency; for instance, the message may contain information about user 104's allergies, current prescriptions, or medical conditions. Alternatively, emergency responder 300 uses a computer or other mobile device (not shown) connected to the Internet to visit website address 208 and logs into emergency module 108 using emergency access code 210. Once logged in, emergency responder 300 views a web page displaying emergency medical information preselected by user 104 prior to the medical emergency. When emergency module 108 of user 104's account has been accessed, emergency module 108 automatically contacts without any external intervention one or more predesignated emergency contacts 304 listed in database 102 either by text message to a cell phone 306 or by email to a computer 308 to notify them of user 104's medical emergency. In another embodiment, the predesignated emergency contacts choose to receive a pre-recorded voice message to a telephone instead of or in addition to the text message. Prior to the emergency, the user is able to customize the emergency medical information available through the voice message, text message, or web page. For instance, the user may include certain information in the voice message but different information in the text message.

Referring to FIG. 3B, in an emergency situation, an emergency responder locates charm 200 or other item worn or carried by user 104 (320). The emergency responder obtains emergency telephone number 206 and emergency access code 210 from charm 200 (322), calls the emergency telephone number (324), and enters emergency access code 210 to log into emergency module 108 of medical records system 100 (326). Once logged in, the emergency responder listens to a voice message and then has the option of hearing the voice message again or receiving it by text message to a cellular telephone. When hearing the voice message the emergency responder listens to a prerecorded voice message containing medical information preselected by user 104 (330). If a text message is selected, the emergency responder provides a phone number where the text message should be sent (332) and receives at least one text message at that phone number containing medical information preselected by user 104 (334). Alternatively, after charm 200 has been located (320), the emergency responder obtains website address 208 and emergency access code 210 from charm 200 (340) and accesses emergency module 108 via computer or other mobile device using website address 208 (342). The emergency responder enters emergency access code 210 to log into emergency module 108 (344) and views a display of medical information preselected by user 104 (346).

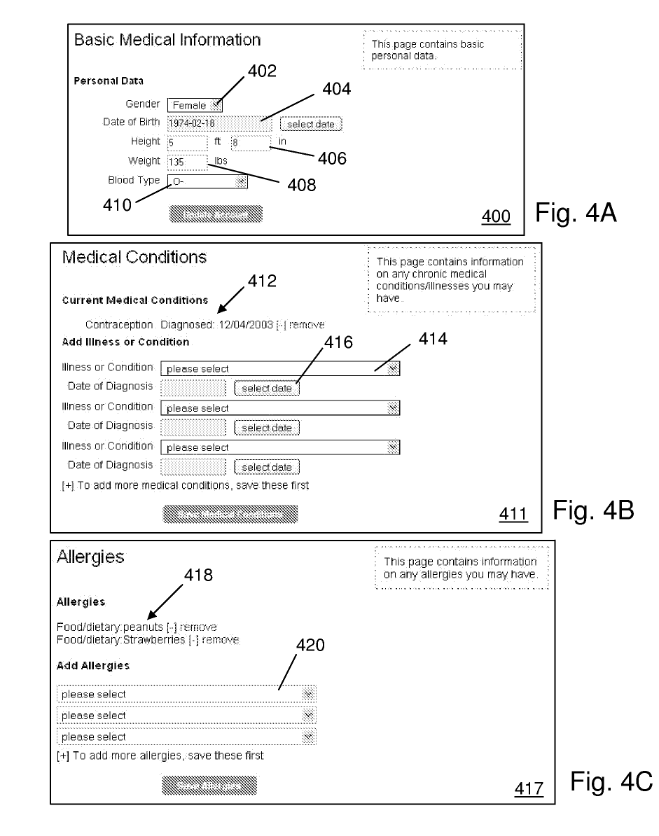

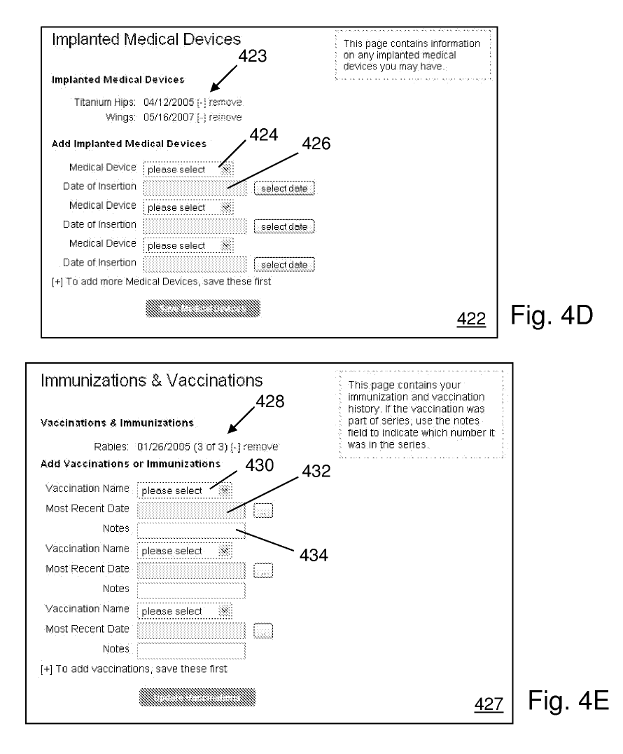

Referring to FIGS. 4A-4E, 5A-5B, 6, 7, 8, and 9A-9B, a user interface to non-emergency module 106 allows user 104 to input and view personal medical information and to select the information provided to an emergency responder in the event of an emergency. The user interface also allows a user to download previously entered personal medical information to a file, such as a PDF file; save the information onto a portable storage medium, such as a compact disc or flash memory; or fax the information to a physician or other recipient. The user interface is also configured to allow a user to fax a cover letter from the system to a physician or medical facility to request a return fax containing lab test results or other medical records. In some embodiments, the user interface accepts medical information from the user via fax.

Referring to FIGS. 4A-4E, a user enters basic information about his or her personal health history into medical records system 100 through the user interface. Referring to FIG. 4A, a basic medical information page 400 of the user interface allows a user to enter, view, or update basic medical information, such as a gender 402, a date of birth 404, a height 406, a weight 408, and a blood type 410. Referring to FIG. 4B, a medical conditions page 411 of the user interface allows a user to view or remove previously entered medical conditions or illnesses 412 and to add new medical conditions or illnesses. To add a new medical condition or illness, the user selects a condition from a drop-down menu 414 and specifies a date of diagnosis 416. The drop-down menu contains an extensive list of conditions and illnesses and also provides an option for the user to enter a condition or illness not included on the list. For example, a medical condition or illness may be anemia, migraines or headaches, or depression. Referring to FIG. 4C, an allergies page 417 of the user interface allows a user to view or remove previously entered allergy information 418 and adds new allergies by selecting an allergy from a list provided in a drop-down menu 420. The drop-down menu 420 contains an extensive list of allergies and also provides an option for the user to enter an allergy not included on the list. For instance, the list includes selections such as allergies to dogs, eggs, and shellfish. Referring to FIG. 4D, an implanted medical device page 422 allows a user to view or remove previously entered implanted medical devices 423 and to add new medical devices. To add a new medical device, the user selects a device from a drop-down menu 424 and specifies a date of insertion 426. The drop-down menu 424 contains a list of medical devices, such as a pacemaker, and also provides an option for the user to enter a medical device not included on the list. Referring to FIG. 4E, an immunizations and vaccinations page 427 allows a user to view or remove previously entered immunizations and vaccinations 428 and to add new vaccinations or immunizations. To add new vaccinations or immunizations, the user selects from a drop-down menu 430, specifies a most recent date of vaccination 432, and optionally includes notes 434 about the vaccination. The drop-down menu 430 contains a list of immunizations and vaccinations, such as Tetanus and Hepatitis B, and also provides an option for a user to enter an immunization not included on the list. In other embodiments, medical records system 100 also accepts other personal medical information such as lab results, X-rays, fingerprints, CAT scans, MRI scans, and vital personal documents such as wills.

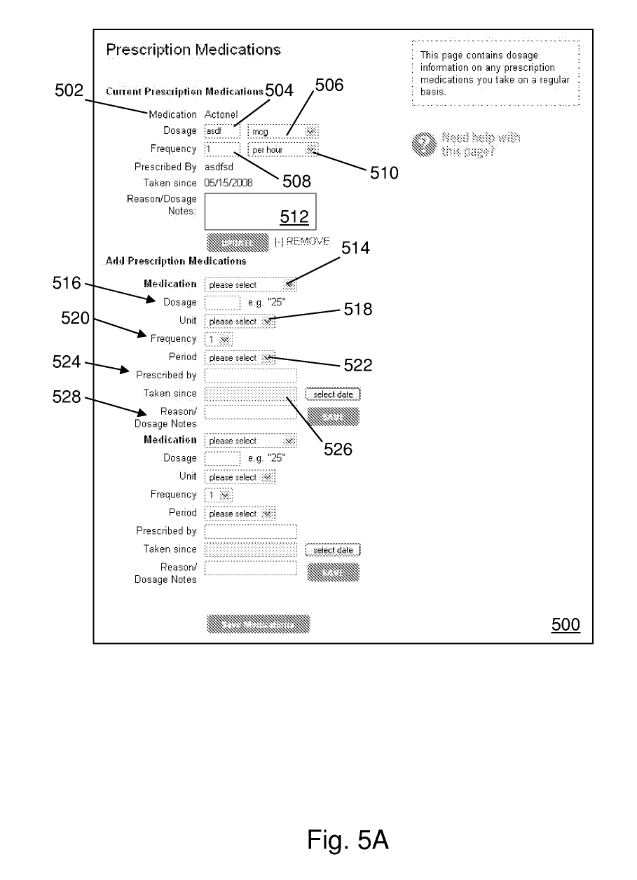

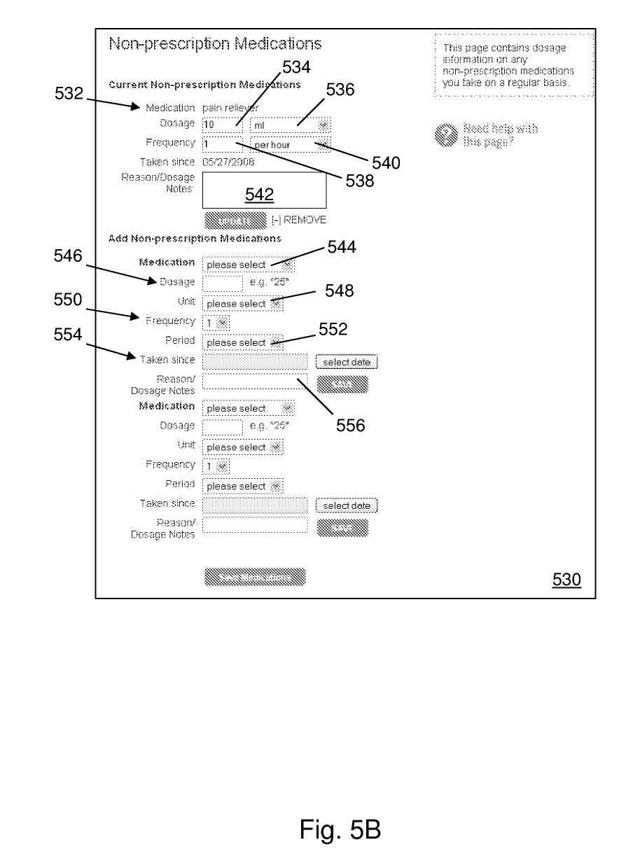

Referring to FIGS. 5A and 5B, information about prescription and non-prescription medications can be entered into medical records system 100 through the user interface. Referring to FIG. 5A, a prescription medication page 500 of the user interface allows a user to view, update, or remove previously entered prescription medications 502 and to add new prescription medications. To update a previously entered prescription medication 502, the user enters a dosage amount 504 and a unit of measure 506 (for example, milligrams or milliliters), a frequency 508 per time period 510 (for example, per hour or per day), and dosage notes 512. To add a new prescription medication, the user selects a medication from a drop-down menu 514, which contains an extensive list of prescription medications and also provides an option for a user to enter a prescription medication not included on the list. For each prescription medication, the user also enters a dosage 516 and unit of measure 518, a frequency 520 per time period 522, a name 524 of a person prescribing the medication, a date 526 when the user first began taking the medication, and dosage notes 528. Referring to FIG. 5B, a non-prescription medication page 530 allows a user to view, update, or remove previously entered non-prescription medications 532 and to add new non-prescription medications. To update a previously entered non-prescription medication 532, the user enters a dosage amount 534 and a unit of measure 536, a frequency 538 per time period 540, and dosage notes 542. To add a new non-prescription medication, the user selects a medication from a drop-down menu 544, which contains a list of non-prescription medications and also provides an option for a user to enter a non-prescription medication not included on the list. For each non-prescription medication, the user also enters a dosage 546, a unit of measure 548, a frequency 550 per time period 552, a date 554 when the user first began taking the medication, and dosage notes 556.

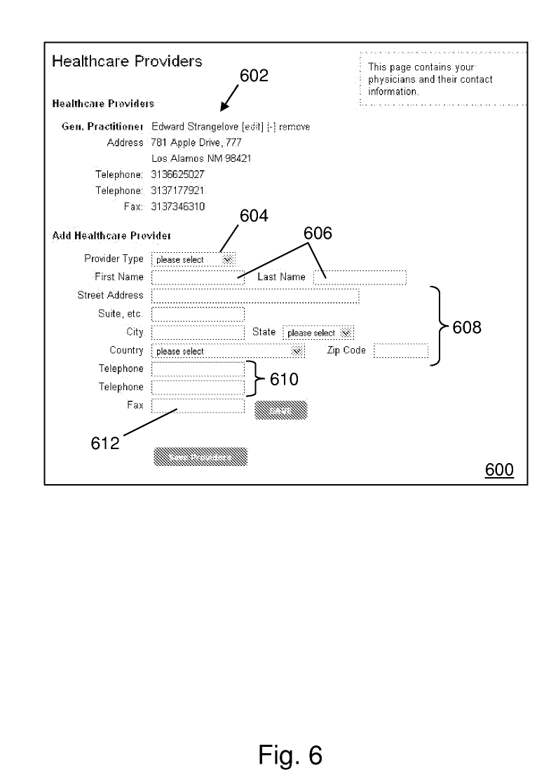

Referring to FIG. 6, information about a user's healthcare providers can be entered into medical records system through a healthcare providers page 600 of the user interface. A user views, updates, or removes previously entered healthcare providers 602 and adds new healthcare providers. To add a new healthcare provider, the user selects a provider type from a drop-down menu 604, which contains a list of provider types and also provides an option for the user to enter a provider type not included on the list. For instance, provider types include a general practitioner, a psychiatrist, and a dentist. The user also enters contact information for each healthcare provider, including a name 606, an address 608, at least one telephone number 610, and a fax number 612.

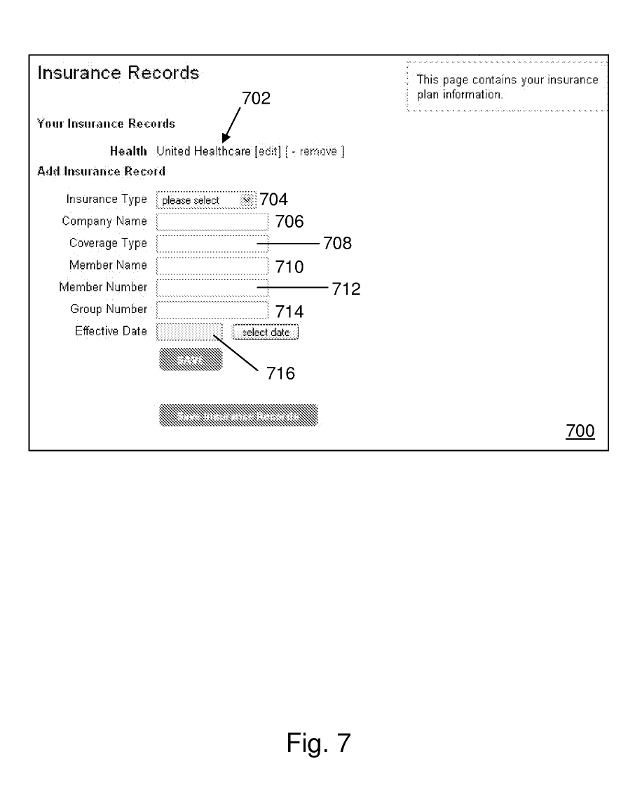

Referring to FIG. 7, a user's insurance information can be entered into medical records system through an insurance records page 700 of the user interface. A user views, edits, or removes previously entered insurance information 702 and adds new insurance information. To add new insurance information, the user selects an insurance type from a drop-down menu 704, which contains a list of insurance types and also provides an option for the user to enter an insurance type not included on the list. For example, insurance types include health, dental, and vision insurance. For each type of insurance, the user enters a name 706 of the insurance company, a type of coverage 708, a member name 710, a member number 712, a group number 714, and an effective date 716.

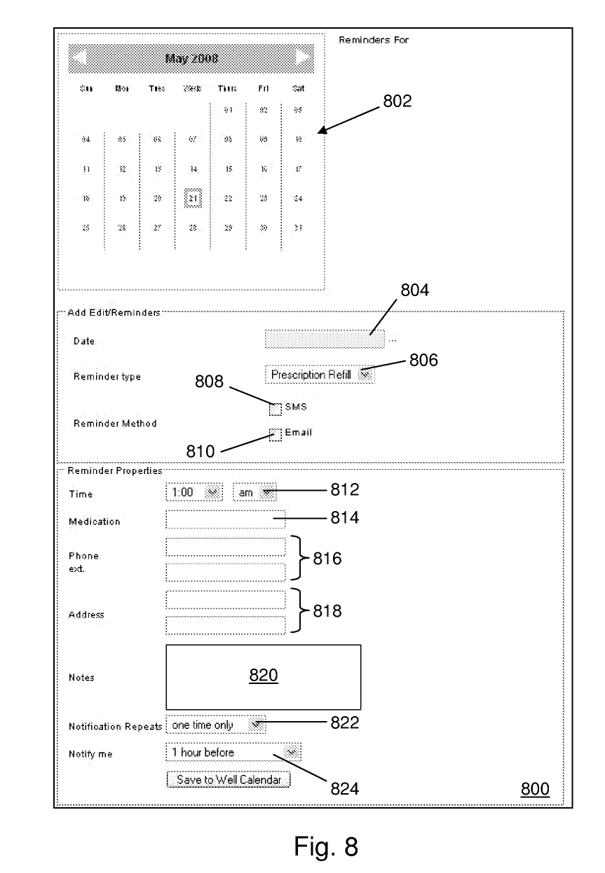

Referring to FIG. 8, a calendar page 800 of the user interface allows a user to enter and view medical events for which he or she wishes to receive a reminder from medical records system 100. A calendar 802 displays medical events previously entered by the user. To add a reminder, the user enters a date 804 of the medical event, and a type 806 of the event (such as a prescription refill, a doctor's visit, or a time to take a medication), and selects to receive the reminder via text message 808 or email 810. The user also enters a time 812 for the medical event and further information about the event, such as a medication name 814, a telephone 816 or address 818, and other notes 820. The user also selects from a first drop-down menu 822 how often the reminder should be sent (for example, one time only, daily, or weekly) and selects from a second drop-down menu 824 how much time in advance of the time 812 of the medical event the reminder should be sent (for example, one hour before, one day before, or one week before).

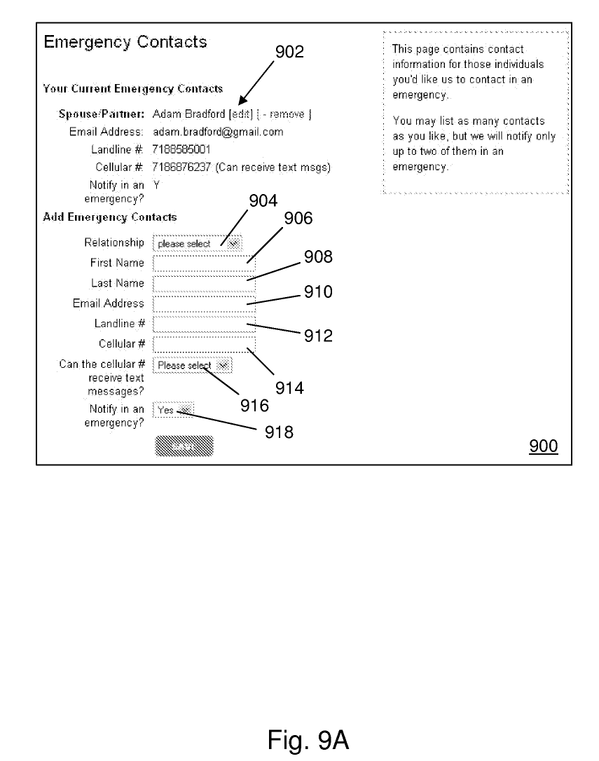

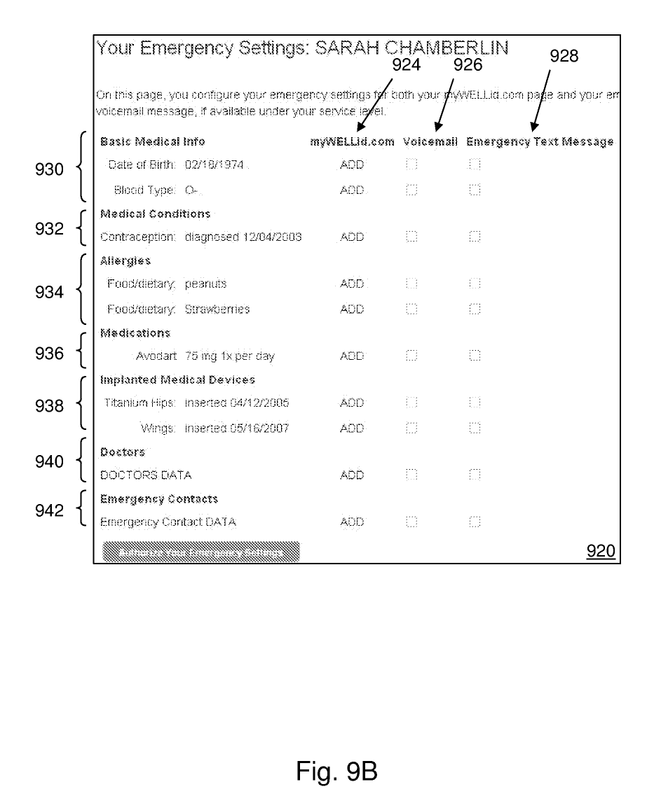

Referring to FIGS. 9A and 9B, a user can configure emergency module 108. Referring to FIG. 9A, an emergency contacts page 900 of the user interface allows a user to view, edit, or remove previously entered emergency contacts 902 that will be notified when emergency module 108 is accessed as described in conjunction with FIG. 3A, and to add new emergency contacts. To add a new emergency contact, the user selects his or her relationship with the emergency contact from a drop-down menu 904. For instance, the emergency contact may be a parent, spouse, or friend of the user. The user also enters contact information for the emergency contact, including a first name 906 and a last name 908, an email address 910, a landline telephone number 912, and a cellular phone number 914. The user indicates in a drop-down menu 916 whether the emergency contact's cellular telephone can receive text messages, and selects from another drop-down menu 918 whether the emergency contact should be contacted in the event of an emergency.

Referring to FIG. 9B, an emergency settings page 920 of the user interface allows a user to check boxes 922 to select emergency information to be conveyed when an emergency responder receives emergency medical information via the Internet (column 924), by voicemail (column 926), or by text message (column 928). For instance, the user may indicate that his or her blood type may be conveyed only over voice mail and text message but not via the Internet. The categories of basic medical information 930, medical conditions 932, allergies 934, medications 936, implanted medical devices 938, doctors 940, and emergency contacts 942 contain the user's medical information that was previously entered through the user interface as described above.

What is claimed is:

1. A method for accessing a person's medical information in an emergency, the medical information stored in a database of a medical records system, the method comprising:
calling an emergency telephone number;
entering an access code to access the medical records system;
receiving a prerecorded message reciting the medical information;
in response to a prompt by the medical records system, choosing to receive the person's medical information via a text message to a cellular telephone;
receiving on a cellular telephone the text message containing the person's medical information;
wherein the steps of calling the emergency telephone number and entering the access code cause the medical records system to automatically notify at least one emergency contact of the person, a telephone number for the at least one emergency contact being stored in the database of the medical records system.

2. The method of claim 1, wherein the emergency contact of the person is automatically notified by an email message.

3. The method of claim 1, wherein the emergency contact of the person is automatically notified by a text message.

4. The method of claim 1, wherein the emergency contact of the person is automatically notified by a telephone call.

5. The method of claim 1, wherein the access code is displayed on an item carried by the person.

6. The method of claim 5, wherein the item is a jewelry charm.

7. The method of claim 5, wherein the person may possess a plurality of items, each having a different access code, each different access code usable to access the person's medical information.

8. A medical records system for providing access to a first person's medical records, the medical records stored in a database of the medical records system, the system comprising:
a non-emergency access module configured to:
accept input of or modifications to the medical records by the first person,
contact the first person with a reminder of an upcoming medical event by sending a text message to a first cellular telephone to which the first person has access,
accept from the first person a selection of a subset of the medical records as emergency medical information, and
accept from the first person a designation of at least one emergency contact; and
an emergency access module configured to:
accept a phone call to an emergency telephone number from a second person,
identify the first person's medical records by an access code entered during the phone call by the second person,
send a text message to a second cellular telephone to which the second person has access, the text message containing the emergency medical information, and
automatically notify the at least one emergency contact of the first person.

9. The system of claim 8, wherein the first person inputs or modifies the medical records by faxing medical records to the medical records system.

10. The system of claim 8, wherein the first person inputs or modifies the medical records using a mobile communication device.

11. The system of claim 8, wherein the access code is displayed on a item worn by the person.

12. The system of claim 11, wherein the item is a jewelry charm.

13. The system of claim 11, wherein the first person may possess a plurality of items, each item having a different access code, each different access code usable to access to the first person's medical records.

14. A method for accessing a person's medical information in an emergency, the medical information stored in a database of a medical records system, the method comprising:
obtaining an address of an emergency website and an access code;
accessing the emergency website using a computer;
entering the access code to access the medical records system;
viewing the person's medical information on the emergency website;
wherein the steps of accessing the emergency website and entering the access code cause the medical records system to automatically notify at least one emergency contact of the person, a telephone number for the at least one emergency contact being stored in the database of the medical records system.

15. The method of claim 14, wherein the access code is displayed on an item carried by the person.

16. The method of claim 15, wherein the item is a jewelry charm.

17. The method of claim 15, wherein the person may possess a plurality of items, each item having a different access code, each different access code usable to access the person's medical information.
